(19) United States
(12) Patent Application Publication
(10) Pub. No.: US 2026/0169352 A1
(43) Pub. Date: Jun. 18, 2026

(54) LINEAR ACTUATOR, INTERCHANGEABLE LENS, AND IMAGING DEVICE

(71) Applicant: Sony Group Corporation, Tokyo (JP)

(72) Inventors: Katsuya Fujii, Tokyo (JP); Tetsu Tanaka, Kanagawa (JP)

(21) Appl. No.: 19/100,318

(22) PCT Filed: Aug. 31, 2023
(86) PCT No.: PCT/JP2023/031740

§ 371 Date: Jan. 31, 2025

(30) Foreign Application Priority Data
Sep. 9, 2022 (JP) 2022-143913

(51) Int. Cl. G03B 5/00; G02B 7/14; G03B 17/14

(52) U.S. Cl. CPC G03B 5/00; G02B 7/14; G03B 17/14; G03B 2205/0069

(57) ABSTRACT

A fixed rod including at least two magnets and at least one inner yoke, the magnets and the inner yoke being alternately coupled, and the magnets having poles of the same polarity coupled to both sides of the inner yoke; and a plurality of tubular movable coils through which the fixed rod is inserted, are provided, the plurality of movable coils is movable in a coupling direction of the magnets and the inner yoke with respect to the fixed rod, and the plurality of movable coils is individually movable with respect to the fixed rod.

### TECHNICAL FIELD

The present technology relates to a technical field of a linear actuator including a magnet and a movable coil and operated by energizing the movable coil, an interchangeable lens including the linear actuator, and an imaging device including the linear actuator.

### BACKGROUND ART

There is a linear actuator that includes a magnet and a movable coil, and applies a driving force to the movable body by energizing the movable coil to move the movable body (see, for example, Patent Document 1, Patent Document 2, and Patent Document 3).

Such a linear actuator is used in various electronic devices including, for example, an interchangeable lens, an imaging device, and the like. In an interchangeable lens, an imaging device, or the like, for example, a movable lens that functions as a zoom lens or a focus lens and a lens holder that holds the movable lens are provided as movable bodies, and zooming, focusing, and the like are performed by moving the movable lens by a driving force of the linear actuator in an optical axis direction together with the lens holder.

In Patent Document 1, a magnet and iron are alternately coupled to form a movable rod, the movable rod is inserted into a coil held by a yoke, and the coil is energized to move the movable rod in an axial direction with respect to the coil.

In Patent Document 2, a magnet and iron are alternately coupled to form a fixed rod, the fixed rod is inserted into a movable coil held by a yoke, and the movable coil is energized to move the movable coil and the yoke together in an axial direction with respect to the fixed rod.

In Patent Document 3, two movable bodies movable in an optical axis direction and two linear actuators for the respective movable bodies are provided, and the movable bodies are configured to be movable in an optical axis direction by the respective linear actuators.

### CITATION LIST

### Patent Document

Patent Document 1: Japanese Patent Application Laid-Open No. 2016-86617

Patent Document 2: Japanese Patent Application Laid-Open No. 2015-173580

Patent Document 3: Japanese Patent Application Laid-Open No. 2006-178006

### SUMMARY OF THE INVENTION

### Problems to be Solved by the Invention

Meanwhile, in recent years, in an imaging device or the like provided with the linear actuator as described above, downsizing is desired from the viewpoint of improvement in portability and the like, and improvement in functionality and the like is desired from the viewpoint of improvement in usability and the like.

In order to improve such functionality, movable bodies such as a plurality of movable lenses are often disposed inside an imaging device or the like, but as the number of movable bodies increases, downsizing may be difficult.

Therefore, an object of a linear actuator, an interchangeable lens, and an imaging device of the present technology is to ensure downsizing while improving functionality.

### Solutions to Problems

A linear actuator according to the present technology includes: a fixed rod including at least two magnets and at least one inner yoke, the magnets and the inner yoke being alternately coupled, and the magnets having poles of the same polarity coupled to both sides of the inner yoke; and a plurality of tubular movable coils through which the fixed rod is inserted, the plurality of movable coils being movable in a coupling direction of the magnets and the inner yoke with respect to the fixed rod, and the plurality of movable coils is individually movable with respect to the fixed rod.

As a result, each of the plurality of movable coils through which the fixed rod is inserted is energized, so that each movable coil is individually moved with respect to the fixed rod.

An interchangeable lens according to the present technology includes: a movable body movable in an optical axis direction; and a linear actuator that moves the movable body in the optical axis direction, the linear actuator including: a fixed rod including at least two magnets and at least one inner yoke, the magnets and the inner yoke being alternately coupled, and the magnets having poles of the same polarity coupled to both sides of the inner yoke; and a plurality of tubular movable coils through which the fixed rod is inserted, the plurality of movable coils being movable in a coupling direction of the magnets and the inner yoke with respect to the fixed rod, and the plurality of movable coils is individually movable with respect to the fixed rod.

As a result, in the linear actuator, each of the plurality of movable coils through which the fixed rod is inserted is energized, so that each movable coil is individually moved with respect to the fixed rod.

An imaging device according to the present technology includes: an imaging element that converts an optical image into an electrical signal; a movable body movable in an optical axis direction; and a linear actuator that moves the movable body in the optical axis direction, the linear actuator including: a fixed rod including at least two magnets and at least one inner yoke, the magnets and the inner yoke being alternately coupled, and the magnets having poles of the same polarity coupled to both sides of the inner yoke; and a plurality of tubular movable coils through which the fixed rod is inserted, the plurality of movable coils being movable in a coupling direction of the magnets and the inner yoke with respect to the fixed rod, and the plurality of movable coils is individually movable with respect to the fixed rod.

As a result, in the linear actuator, each of the plurality of movable coils through which the fixed rod is inserted is energized, so that each movable coil is individually moved with respect to the fixed rod.

### BRIEF DESCRIPTION OF DRAWINGS

FIG. 1 illustrates an embodiment of a linear actuator, an interchangeable lens, and an imaging device of the present technology together with FIGS. 2 to 22, and is a perspective view illustrating the interchangeable lens and the imaging device.

FIG. 2 is a perspective view illustrating the internal structure of the interchangeable lens in which a part is cut out.

FIG. 3 is a perspective view illustrating the internal structure of the interchangeable lens in which a part is cut out and an outer yoke is separated.

FIG. 4 is a cross-sectional view taken along line IV-IV of FIG. 2.

FIG. 5 is a cross-sectional view taken along line V-V of FIG. 2.

FIG. 6 is a front view illustrating the internal structure of the interchangeable lens.

FIG. 7 is a perspective view of the linear actuator.

FIG. 8 is a cross-sectional view of the linear actuator.

FIG. 9 is a conceptual diagram illustrating a magnetic flux generation state in the linear actuator.

FIG. 10 is another conceptual diagram illustrating a magnetic flux generation state in the linear actuator.

FIG. 11 is a conceptual diagram illustrating a state of a magnetic flux generated from a magnet.

FIG. 12 is a conceptual diagram illustrating forces generated in magnets and an inner yoke.

FIG. 13 is a perspective view illustrating a linear actuator having an outer yoke according to a first modification.

FIG. 14 is a perspective view illustrating a linear actuator having an outer yoke according to a second modification.

FIG. 15 is a perspective view illustrating a linear actuator having an outer yoke according to a third modification.

FIG. 16 is a perspective view illustrating a linear actuator having an outer yoke according to a fourth modification.

FIG. 17 is a perspective view illustrating a linear actuator having an outer yoke according to a fifth modification.

FIG. 18 is a perspective view illustrating a linear actuator having an outer yoke according to a sixth modification.

FIG. 19 is a perspective view illustrating a linear actuator having an outer yoke according to a seventh modification.

FIG. 20 is a graph indicating the magnitude of the magnetic attraction force with respect to the position on the fixed rod.

FIG. 21 is a graph indicating the magnitude of the thrust with respect to the position of the coil, on the fixed rod.

FIG. 22 is a block diagram of the imaging device.

### MODE FOR CARRYING OUT THE INVENTION

Hereinafter, an embodiment for implementing the present technology will be described with reference to accompanying drawings.

In the embodiments described below, the linear actuator of the present technology is applied to a linear actuator provided in an interchangeable lens attached to and detached from an imaging device that is a still camera. Note that the application range of the present technology is not limited to the linear actuator provided in the interchangeable lens, and can also be applied to a linear actuator provided in an imaging device, and can also be applied to a linear actuator provided in various electronic devices other than the imaging device.

In the following description, it is assumed that front, rear, upper, lower, left, and right directions are indicated as directions viewed from a photographer at the time of capturing an image by an imaging device. Therefore, the subject side (object side) is the front, and the image plane side is the rear. Note that, the front-rear, up-down, and right-left directions below are for convenience of description, and the implementation of the present technology is not limited to these directions.

Furthermore, a lens group described below may include one or a plurality of lenses, or may include one or a plurality of lenses and other optical elements such as a diaphragm and an iris.

### Configuration of Imaging Device

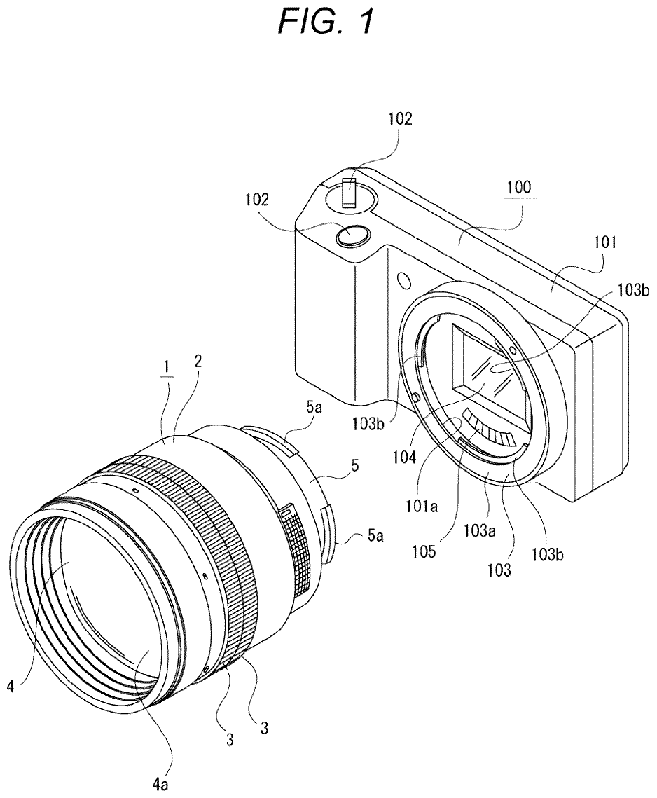

First, a configuration of an imaging device 100 to and from which an interchangeable lens 1 is attached and detached will be described (see FIG. 1).

The imaging device 100 is formed by arranging predetermined units inside and outside a housing 101. For example, a plurality of operation units 102 of various types is disposed on the upper surface and the rear surface of the housing 101. As the operation units 102, for example, a power button, a shutter button, a zoom knob, a mode switching knob, and the like are provided.

A display (display unit) (not illustrated) is disposed on the rear surface of the housing 101.

A circular opening 101a is formed in a front surface of the housing 101, and a mount portion 103 for attaching the interchangeable lens 1 is provided in a portion around the opening 101a. The mount portion 103 has an annular coupling ring 103a and a plurality of arc-shaped mount engagement portions 103b protruding inward from the coupling ring 103a, and the plurality of mount engagement portions 103b is provided to be spaced apart in the circumferential direction.

An imaging element 104 such as a charge coupled device (CCD) or a complementary metal-oxide semiconductor (CMOS) is disposed inside the housing 101, and the imaging element 104 is located behind the opening 101a.

An arc-shaped contact portion 105 is disposed at a lower end portion inside the mount portion 103.

### Configuration of Interchangeable Lens

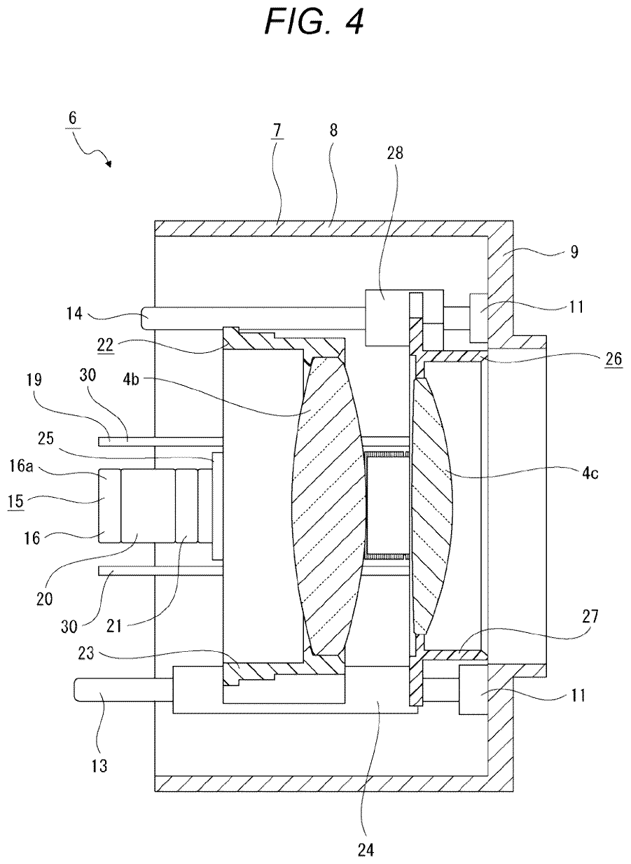

Next, a configuration of the interchangeable lens 1 will be described (see FIGS. 1 to 8).

The interchangeable lens 1 is detachably attached to the imaging device 100, and includes predetermined units disposed inside and outside an outer cylinder 2 (see FIG. 1).

On the outer peripheral surface of the outer cylinder 2, for example, a plurality of adjustment rings 3 is rotatably supported in a state of being arranged in the front-rear direction. The adjustment rings 3 have functions of performing, for example, focusing adjustment, zooming adjustment, light amount adjustment of a diaphragm, and the like.

Inside the outer cylinder 2, a plurality of lenses included in a lens group 4 is arranged to be spaced apart in the optical axis direction (front-rear direction) . The lens group 4 includes at least one lens, and a front lens 4a located on the foremost side and another lens located on the rear side of the front lens 4a are disposed, as parts of the lens group 4, inside the outer cylinder 2.

A lens mount 5 is attached to a rear end portion of the outer cylinder 2. The lens mount 5 includes a plurality of engaging protrusions 5a protruding outward and spaced apart in the circumferential direction. A connection terminal (not illustrated) is provided on a rear end surface of the lens mount 5.

The interchangeable lens 1 is attached to the imaging device 100 by coupling the lens mount 5 to the mount portion 103. The interchangeable lens 1 can be attached to the imaging device 100 by rotating the entire interchangeable lens 1 around the optical axis with respect to the imaging device 100.

In a state where the interchangeable lens 1 is attached to the imaging device 100, the connection terminal is connected to the contact portion 105 of the imaging device 100. Therefore, the interchangeable lens 1 and the imaging device 100 can exchange signals and supply power.

The interchangeable lens 1 can be detached from the imaging device 100 by rotating the entire interchangeable lens 1 around the optical axis with respect to the imaging device 100 in a direction opposite to the direction when attaching and moving the interchangeable lens 1 away from the imaging device 100.

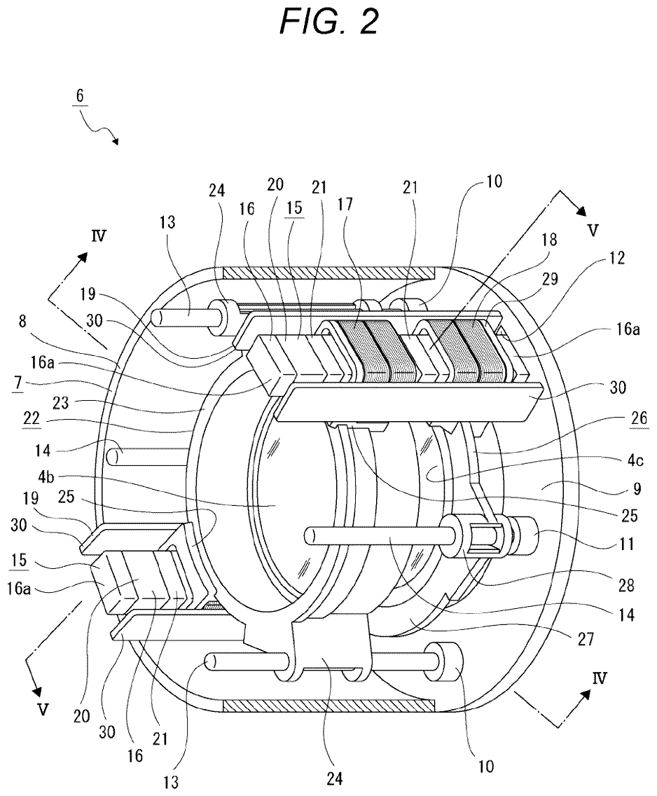

A mechanism unit 6 is disposed inside the interchangeable lens 1 (see FIGS. 2 to 6). The mechanism unit 6 is formed by disposing or supporting predetermined units in an inner cylinder 7. Note that, in the interchangeable lens 1, the inner cylinder 7 may be integrally provided with the outer cylinder 2 as a part of the outer cylinder 2.

The inner cylinder 7 includes a non-magnetic material such as a resin material or a magnetic material, and includes a cylindrical main body portion 8 having an axial direction in the optical axis direction (front-rear direction), and an inner flange portion 9 protruding inward from one end portion of the main body portion 8 in the axial direction.

In the inner flange portion 9, two first bearing protrusions 10 are provided at positions spaced apart in the circumferential direction. In the inner flange portion 9, two second bearing protrusions 11 are provided at positions spaced apart in the circumferential direction, and the second bearing protrusions 11 are located spaced apart from the first bearing protrusions 10 in the circumferential direction.

Two holding recesses 12 are formed in the inner flange portion 9. The holding recesses 12 are formed in a shape opened forward, and is located between the first bearing protrusions 10 and the second bearing protrusions 11. The inner flange portion 9 is provided with yoke attachment portions (not illustrated) at positions on both sides of the holding recesses 12 in the circumferential direction.

One end portions of the two first guide shafts 13 and one end portions of the two second guide shafts 14 are attached to the inner cylinder 7 (see FIGS. 2 to 4). The first guide shafts 13 have rear end portions attached to the first bearing protrusions 10 and front end portions attached to a first bearing (not illustrated). The second guide shafts 14 have rear end portions attached to the second bearing protrusions 11 and front end portions attached to a second bearing (not illustrated).

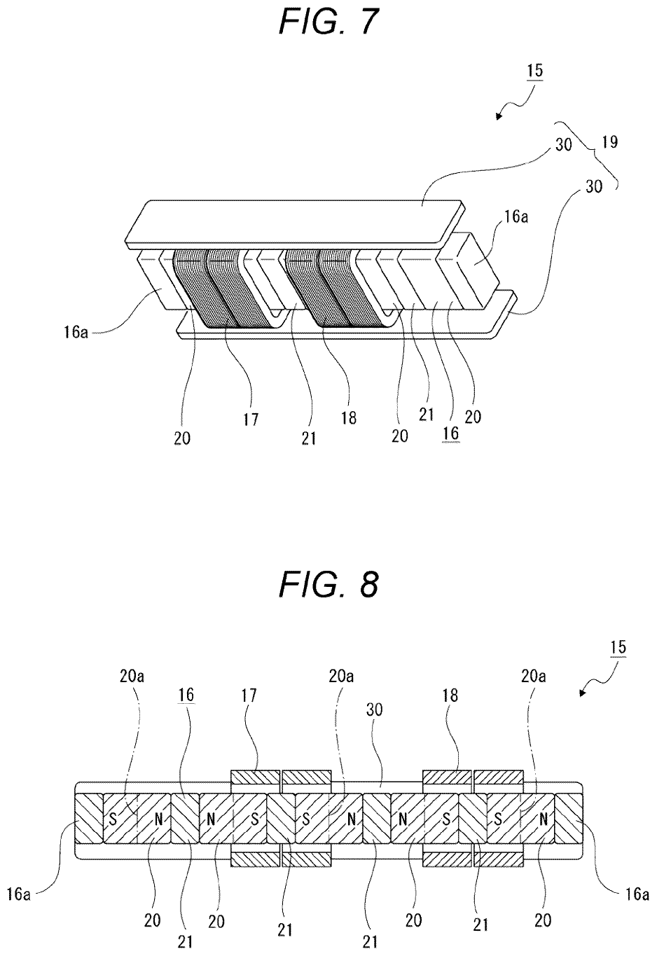

In the inner cylinder 7, linear actuators 15 in a pair are disposed on the opposite sides across the central axis of the main body portion 8 (see FIGS. 2 to 6). The linear actuators 15 each include a fixed rod 16, a first movable coil 17, a second movable coil 18, and an outer yoke 19 (see FIGS. 7 and 8).

The fixed rod 16 includes a plurality of magnets 20 and a plurality of inner yokes 21, and the magnets 20 and the inner yokes 21 are alternately coupled linearly in the front-rear direction by, for example, adhesion. The fixed rod 16 is formed to have, for example, a substantially rectangular cross-sectional shape in the direction orthogonal to the coupling direction of the magnets 20 and the inner yokes 21.

The magnets 20 have N poles and S poles magnetized in the coupling direction of the magnets 20 and the inner yokes 21 (see FIG. 8). In the fixed rod 16, poles of the same polarity of the magnets 20 adjacent via each of the inner yokes 21 are coupled to the inner yoke 21 located between the adjacent magnets 20, and the N pole and the N pole face each other via the inner yoke 21, or the S pole and the S pole face each other via the inner yoke 21.

The magnets 20 each are set such that a boundary 20a between the N pole and the S pole is at a predetermined position in the coupling direction. Therefore, regardless of the respective lengths of the magnets 20 and the inner yokes 21 in the coupling direction, the positions of the boundaries 20a are determined at predetermined positions.

The inner yokes 21 include a magnetic material such as iron. The inner yokes 21 are formed to have an outer shape that is the same as the outer shape of the magnets 20 and a size in the coupling direction smaller than that of the magnets 20, for example.

Coupling members 16a called side yokes are provided at both ends of the fixed rod 16 in the coupling direction, and the coupling members 16a are attached to the magnets 20 by, for example, adhesion (see FIGS. 7 and 8). Similarly to the inner yokes 21, the coupling members 16a also include a magnetic material such as iron.

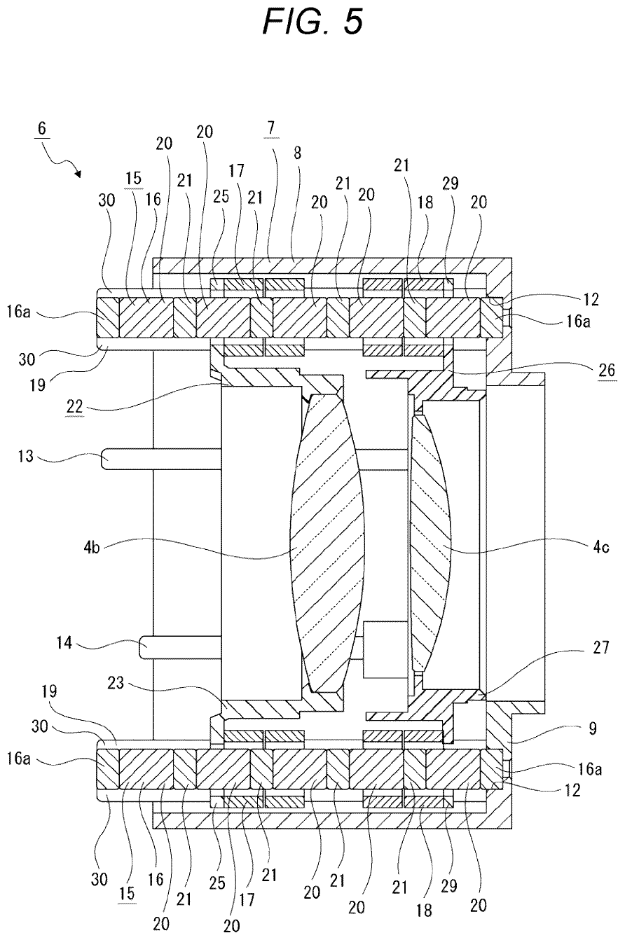

The first movable coil 17 and the second movable coil 18 are formed in a substantially rectangular cylindrical shape as a whole according to the shape of the fixed rod 16. One fixed rod 16 is inserted through the first movable coil 17 and the second movable coil 18 (see FIGS. 5, 7, and 8). Note that the number of movable coils into which one fixed rod 16 is inserted is arbitrary as long as it is plural, and the same number as the number of movable bodies to be described later is provided. For example, in a case where three movable bodies are provided, one fixed rod 16 is inserted into the three movable coils.

The first movable coil 17 and the second movable coil 18 each are formed in, for example, a two-phase configuration, and is configured such that a coil portion forming a first phase and a coil portion forming a second phase are arranged next to each other. A predetermined gap through which a winding wire passes is formed between the coil portion forming the first phase and the coil portion forming the second phase, and the gap is filled with an adhesive to form each of the first movable coil 17 and the second movable coil 18.

When the first movable coil 17 is energized, thrust is generated in the first movable coil 17 in relation to the magnetic flux generated in the fixed rod 16, and the first movable coil 17 is moved in the coupling direction (optical axis direction) of the fixed rod 16 according to the direction of energization to the first movable coil 17. Therefore, in the linear actuator 15, the fixed rod 16 functions as a fixed portion, and the first movable coil 17 functions as a movable portion.

Furthermore, when the second movable coil 18 is energized, thrust is generated in the second movable coil 18 in relation to the magnetic flux generated in the fixed rod 16, and the second movable coil 18 is moved in the coupling direction (optical axis direction) of the fixed rod 16 according to the direction of energization to the second movable coil 18. Therefore, in the linear actuator 15, the second movable coil 18 also functions as a movable portion.

The outer yoke 19 includes a pair of facing portions 30 formed in a flat plate shape including, for example, a magnetic material such as iron. The facing portions 30 in a pair are located on the opposite sides across the fixed rod 16, the first movable coil 17, and the second movable coil 18, and are disposed to cover parts of the fixed rod 16, the first movable coil 17, and the second movable coil 18 from the outer peripheral side thereof. The size of the facing portions 30 in the longitudinal direction is substantially the same as the length of the fixed rod 16 in the coupling direction.

In the linear actuator 15 configured as described above, the rear end portion of the fixed rod 16 is attached to the inner cylinder 7 (see FIGS. 2, 3, and 5). The rear end portion of the fixed rod 16 is attached to the inner cylinder 7 by inserting a part of one of the coupling members 16a into the holding recess 12 in the inner flange portion 9 and coupling the coupling member 16a to the inner flange portion 9 by screwing or the like. The other coupling member 16a of the fixed rod 16 is fixed to a fixing member (not illustrated).

The pair of facing portions 30 of the outer yoke 19 has rear end portions attached to yoke attachment portions provided in the inner flange portion 9 of the inner cylinder 7 and front end portions attached to attachment members (not illustrated).

As described above, the outer yoke 19 is attached to the inner cylinder 7 and the attachment members, and thus functions as a fixed portion. Therefore, in the linear actuator 15, the fixed rod 16 and the outer yoke 19 function as a fixed portion, and the first movable coil 17 and the second movable coil 18 function as a movable portion.

On each of the first guide shafts 13, a first lens holder 22 and a lens 4b provided as movable bodies are supported so as to be movable in the optical axis direction (see FIGS. 2 to 6). The lens 4b is a lens in the lens group 4, is held by the first lens holder 22, and functions as, for example, a focus lens or a zoom lens.

The first lens holder 22 includes a frame-shaped lens holding portion 23, two supported portions 24 protruding in opposite directions on the outer peripheral side from the lens holding portion 23, and two coil attachment portions 25 protruding in opposite directions on the outer peripheral side from the lens holding portion 23. The supported portions 24 and the coil attachment portions 25 protrude from different positions in the circumferential direction of the lens holding portion 23.

The lens 4b is held by the lens holding portion 23. The lens 4b is attached to the lens holding portion 23 by adhesion, press-fitting, or the like.

The supported portions 24 are slidably supported by the first guide shaft 13. Therefore, the first lens holder 22 and the lens 4b are integrally guided by the first guide shaft 13 and moved in the optical axis direction.

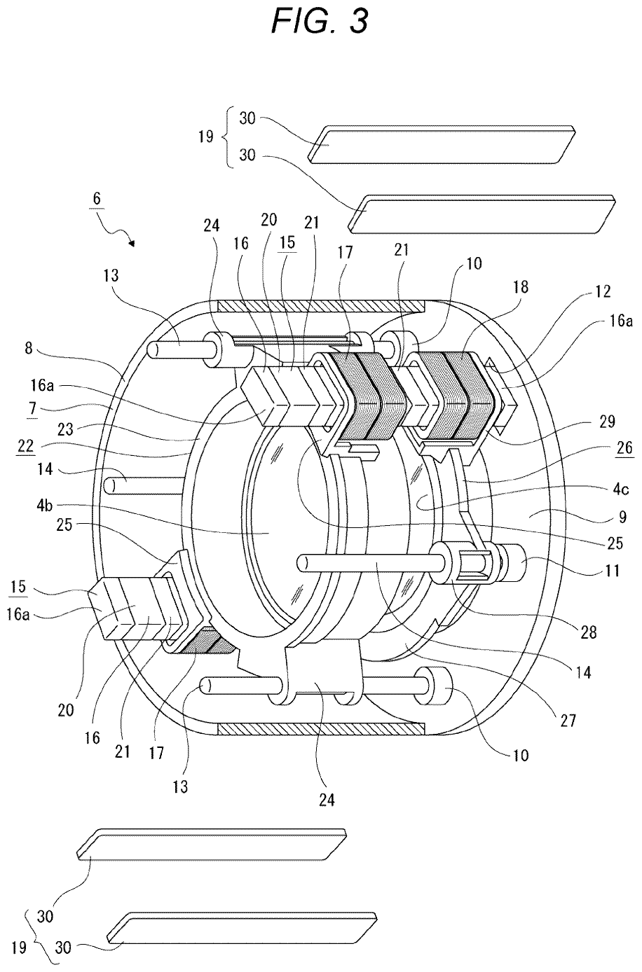

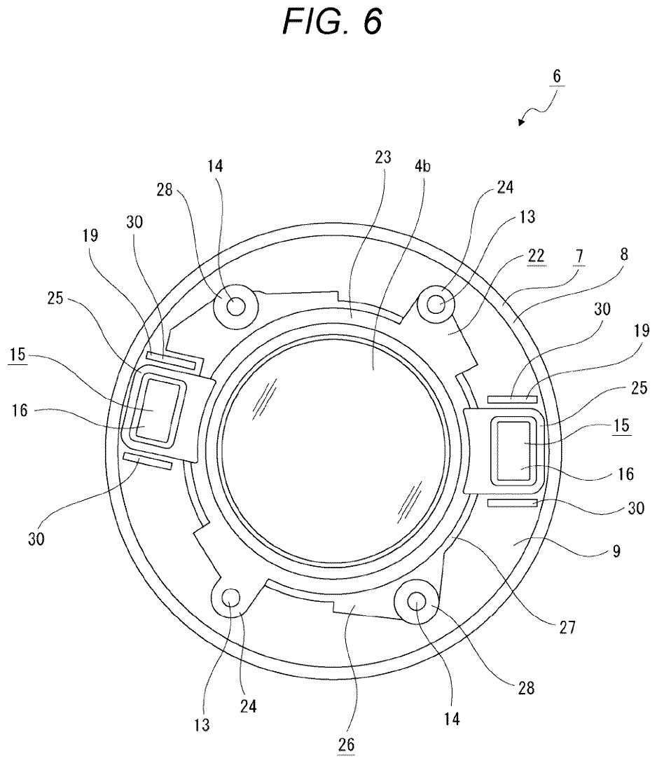

The first movable coils 17 are attached to the coil attachment portions 25 by adhesion or the like (see FIGS. 3 and 6). Therefore, when the first movable coil 17 is energized and the first movable coil 17 is moved in the optical axis direction with respect to the fixed rod 16, the first lens holder 22 and the lens 4b are moved in the optical axis direction along with the first movable coil 17, and the first movable coil 17, the lens 4b, and the first lens holder 22 function as movable bodies.

A second lens holder 26 and a lens 4c provided as movable bodies are supported by the second guide shafts 14 so as to be movable in the optical axis direction (see FIGS. 2 to 5). The second lens holder 26 and the lens 4c are located behind the first lens holder 22 and the lens 4b. The lens 4c is a lens in the lens group 4, is held by the second lens holder 26, and functions as, for example, a focus lens or a zoom lens.

The second lens holder 26 includes a frame-shaped lens holding portion 27, two supported portions 28 protruding in opposite directions on the outer peripheral side from the lens holding portion 27, and two coil attachment portions 29 protruding in opposite directions on the outer peripheral side from the lens holding portion 27. The supported portions 28 and the coil attachment portions 29 protrude from different positions in the circumferential direction of the lens holding portion 27.

The lens 4c is held by the lens holding portion 27. The lens 4c is attached to the lens holding portion 27 by adhesion, press-fitting, or the like.

The supported portions 28 are slidably supported by the second guide shafts 14. Therefore, the second lens holder 26 and the lens 4c are integrally guided by the second guide shafts 14 and moved in the optical axis direction.

The second movable coil 18 is attached to the coil attachment portion 29 by adhesion or the like (see FIG. 3). Therefore, when the second movable coil 18 is energized and the second movable coil 18 is moved in the optical axis direction with respect to the fixed rod 16, the second lens holder 26 and the lens 4c are moved in the optical axis direction along with the second movable coil 18, and the second movable coil 18, the lens 4c, and the second lens holder 26 function as movable bodies.

By moving at least one of the lens 4b or the lens 4c in the optical axis direction, for example, focusing or zooming is performed.

### Relationship between Magnetic Flux and Movable Coil, and the Like

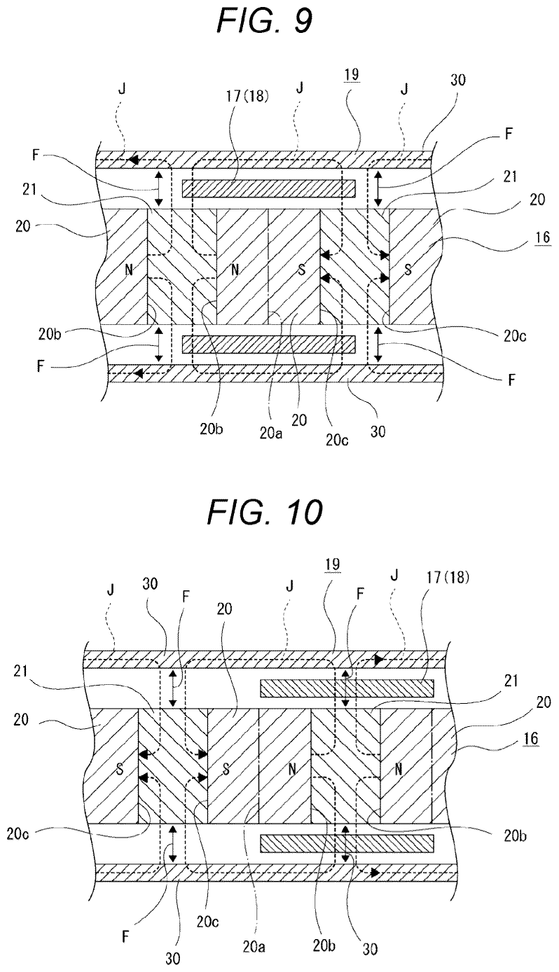

Next, a relationship between the magnetic flux generated in the linear actuator 15 and the first movable coil 17 (second movable coil 18) and the like will be described (see FIGS. 9 to 12). Note that, since the relationship and the like between the magnetic flux and the first movable coil 17 and the relationship and the like between the magnetic flux and the second movable coil 18 are the same, the relationship and the like between the magnetic flux and the first movable coil 17 will be described below as an example. In addition, FIGS. 9 to 11 are conceptual diagrams for easily describing the relationship and the like between the magnetic flux generated in the linear actuator 15 and the first movable coil 17.

As described above, in the fixed rod 16 of the linear actuator 15, the magnets 20 and the inner yokes 21 are alternately coupled, in each of the magnets 20, the N pole and the S pole are magnetized in the coupling direction, and the N pole and the N pole, or the S pole and the S pole, which are the same poles of the magnets 20 adjacent via the inner yoke 21, are coupled to both surfaces of the inner yoke 21 (see FIGS. 9 and 10).

Note that FIG. 9 is an example illustrating a state in which the center of the first movable coil 17 in the axial direction is located to coincide with the center of the magnet 20 in the coupling direction, and FIG. 10 is an example illustrating a state in which the center of the first movable coil 17 in the axial direction is located to coincide with the center of the inner yoke 21 in the coupling direction.

With a definition that the pair of facing portions 30 of the outer yoke 19 is located in the vertical direction and a direction in which the facing portions 30 do not exist is the left-right direction, in the vertical direction, the magnetic flux J generated in the magnet 20 passes from the N pole through the inner yoke 21 through the facing portions 30 of the outer yoke 19 and across the first movable coil 17 coupled to one surface of the magnet 20, and passes through the inner yoke 21 coupled to the other surface of the magnet 20 and across the first movable coil 17 again to reach the S pole (see FIGS. 9 and 10). On the other hand, in the left-right direction, the magnetic flux J generated in the magnet 20 passes from the N pole through the inner yoke 21 coupled to one surface of the magnet 20 and across the first movable coil 17, and passes through the inner yoke 21 coupled to the other surface of the magnet 20 and across the first movable coil 17 again to reach the S pole.

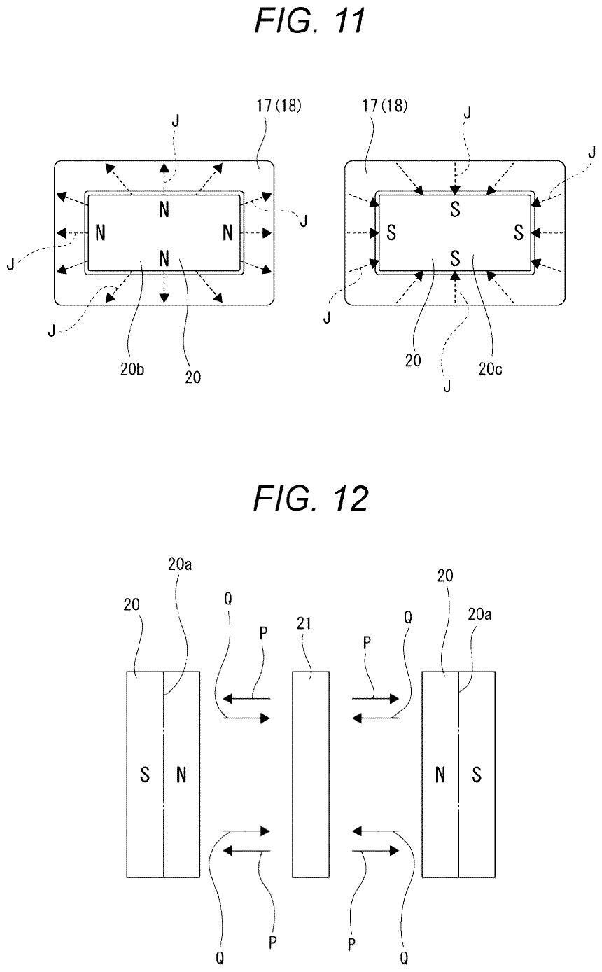

Therefore, the magnetic flux J crosses the entire circumference of the first movable coil 17 (see FIG. 11). Since the magnetic flux J crosses the entire circumference of the first movable coil 17 in this manner, the magnetic flux J greatly contributes to the thrust of the first movable coil 17 to generate the thrust in the entire circumference of the first movable coil 17, and high driving efficiency in the linear actuator 15 can be secured.

Furthermore, since thrust is generated in the entire circumference of the first movable coil 17 and high driving efficiency in the linear actuator 15 can be secured, sufficient driving force can be secured even if each unit in the linear actuator 15 is reduced in size, and the linear actuator 15 can be reduced in size and weight.

Moreover, since the magnetic flux J that has crossed the first movable coil 17, except for a part thereof, passes through the two facing portions 30 located on the outer peripheral side of the first movable coil 17 and flows toward the S pole, the magnetic flux leakage is reduced by the outer yoke 19, and the thrust of the first movable coil 17 can be further improved.

On the other hand, in the linear actuator 15, the same poles of the adjacent magnets 20 are coupled to the inner yoke 21 (see FIG. 12). Therefore, the repulsive force P is generated between the adjacent magnets 20, but in the linear actuator 15, since the inner yoke 21 is disposed between the adjacent magnets 20, an attraction force Q is generated between the inner yoke 21 and the magnets 20, which reduces the repulsive force P generated between the magnets 20.

Furthermore, since the inner yoke 21 is disposed between the adjacent magnets 20, the adjacent magnets 20 are disposed with a constant distance therebetween, which also reduces the repulsive force P generated between the magnets 20.

Therefore, the difficulty of assembling the fixed rod 16 due to the generation of the repulsive force P at the time of coupling the magnets 20 and the inner yokes 21 is reduced, and the fixed rod 16 having a configuration in which the same poles of the adjacent magnets 20 are coupled to the inner yoke 21 can be assembled in an easy and stable state.

In the linear actuator 15, since the outer yoke 19 is disposed outside the fixed rod 16, the generation of the leakage magnetic flux can be reduced as described above, but the existence of the outer yoke 19 generates the magnetic attraction force F between the outer yoke 19 and the fixed rod 16 (see FIGS. 9 and 10). At this time, a load is generated in a direction in which the fixed rod 16 is attracted toward the facing portions 30 by the magnetic attraction force F and is deformed.

However, in the linear actuator 15, the outer yoke 19 includes the facing portions 30 in a pair located on the opposite sides across the fixed rod 16.

Therefore, attraction forces for attracting the fixed rod 16 in the opposite directions are generated by the pair of facing portions 30, the forces make a force in a direction bending the fixed rod 16 to be hardly generated, so that the deformation of the fixed rod 16 can be suppressed.

In addition, since the leakage magnetic flux is reduced by the pair of facing portions 30, the driving efficiency for the first movable coil 17 and the second movable coil 18 can be improved.

### Modification of Outer Yoke

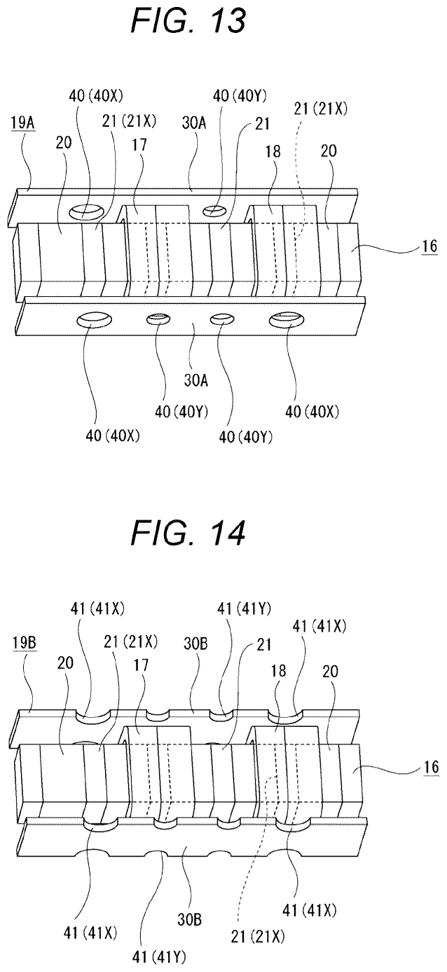

Next, modifications of the outer yoke will be described (see FIGS. 13 to 19). Note that each modification of the outer yoke (first to seventh modifications) described below can be used not only in the above-described example in which a plurality of movable coils is movable with respect to the fixed rod 16, and may be used in examples in which one movable coil is movable with respect to the fixed rod 16.

The outer yoke 19A according to the first modification is formed in a shape in which a plurality of work holes 40 is formed in facing portions 30A (see FIG. 13). The work holes 40 work to reduce the magnetic flux density generated in the facing portions 30A by the fixed rod 16.

The work holes 40 are located apart from each other in the coupling direction of the magnets 20 and the inner yokes 21, and are formed at positions corresponding to the inner yokes 21, for example. The shape of the work holes 40 is, for example, a circular shape, but may be other shapes such as a rectangular shape. However, since formation of the work holes 40 in a circular shape makes it hard to concentrate stress at the opening edges of the work holes 40 and the work holes 40 in a circular shape can be machined easily, so that the strength of the outer yoke 19A can be improved and manufacturing cost can be reduced.

Since the formation of the work holes 40 in the facing portions 30A as described above reduces the magnetic flux density generated in the outer yoke 19A by the fixed rod 16, the magnetic attraction force of the outer yoke 19A with respect to the fixed rod 16 is reduced, the deformation of the fixed rod 16 is effectively suppressed, and the reliability of the operation of the linear actuator 15 can be improved.

In addition, since the work holes 40 are formed at the positions corresponding to the inner yokes 21, the work holes 40 are located corresponding to the portions of the highest magnetic flux densities in the fixed rod 16, so that the effect of reducing the magnetic attraction forces of the facing portions 30A with respect to the fixed rod 16 is enhanced, and the deformation of the fixed rod 16 can be more effectively prevented.

Note that with a definition that the inner yokes 21 located at both ends of the fixed rod 16 are end-side inner yokes 21X, the size of first work holes 40X formed at positions corresponding to the end-side inner yokes 21X may be larger than the size of second work holes 40Y formed at positions corresponding to the inner yokes 21 other than the end-side inner yokes 21X.

Therefore, the configuration of the work holes 40 to have different sizes depending on the positions as described above reduces the thrust of the first movable coil 17 and the thrust of the second movable coil 18 at both ends of the fixed rod 16, and reduces the difference in the thrust of the first movable coil 17 and the second movable coil 18 in portions other than both ends of the fixed rod 16, so that it is possible to ensure an appropriate moving state of the first movable coil 17 and the second movable coil 18 with respect to the fixed rod 16.

Although the example of the outer yoke 19A in which the work holes 40 are formed has been described above, as a second modification, an outer yoke 19B in which work notches 41 are formed instead of the work holes 40 may be configured (see FIG. 14). The outer yoke 19B is formed in a shape in which a plurality of work notches 41 is formed in facing portions 30B, and the work notches 41 work to reduce the magnetic flux density generated in the facing portions 30B by the fixed rod 16, similarly to the work holes 40.

The work notches 41 are located apart from each other in the coupling direction of the magnets 20 and the inner yokes 21, and are formed on both sides of the facing portions 30B in the width direction at positions corresponding to the inner yokes 21, for example. The shape of the work notches 41 is, for example, a semicircular shape, but may be other shapes such as a rectangular shape. However, since formation of the work notches 41 in a semicircular shape makes it hard to concentrate stress at the opening edges of the work notches 41, and the work notches 41 in a semicircular shape can be machined easily, so that the strength of the outer yoke 19B can be improved and the manufacturing cost can be reduced.

Since the formation of the work notches 41 in the facing portions 30B as described above reduces the magnetic flux density generated in the outer yoke 19B by the fixed rod 16, the magnetic attraction force of the outer yoke 19B with respect to the fixed rod 16 is reduced, the deformation of the fixed rod 16 is effectively suppressed, and the reliability of the operation of the linear actuator 15 can be improved.

In addition, since the work notches 41 are formed at the positions corresponding to the inner yokes 21, the work notches 41 are located corresponding to the portions of the highest magnetic flux densities in the fixed rod 16, so that the effect of reducing the magnetic flux densities generated in the facing portions 30B by the fixed rod 16 is enhanced, and the deformation of the fixed rod 16 can be more effectively prevented.

Moreover, similarly to the outer yoke 19A, the outer yoke 19B may be configured such that the size of the first work notches 41X formed at the positions corresponding to the end-side inner yokes 21X is larger than the size of second work notches 41Y formed at the positions corresponding to the inner yokes 21 other than the end-side inner yokes 21X.

The configuration described above reduces the thrust of the first movable coil 17 and the thrust of the second movable coil 18 at both ends of the fixed rod 16, and reduces the difference in the thrust of the first movable coil 17 and the second movable coil 18 in portions other than both ends of the fixed rod 16, so that it is possible to ensure an appropriate moving state of the first movable coil 17 and the second movable coil 18 with respect to the fixed rod 16.

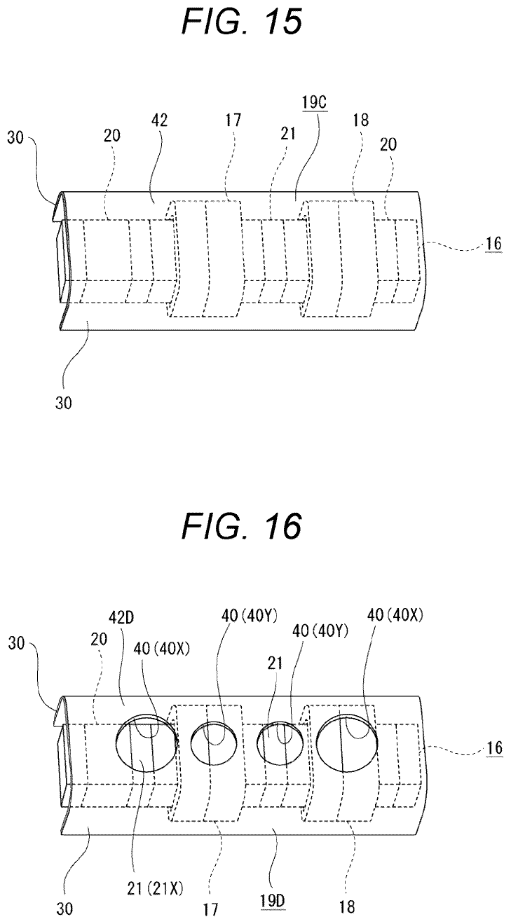

An outer yoke 19C according to the third modification includes a coupling portion 42 that couples the facing portions 30 in a pair in addition to the pair of facing portions 30 (see FIG. 15). In the outer yoke 19C, all of the facing portions 30 in a pair and the coupling portion 42 are formed to have a flat plate shape, and the pair of facing portions 30 and the coupling portion 42 are integrally formed.

In a case where the outer yoke 19C is used, the fixed rod 16 is covered with the outer yoke 19C from three sides on the outer peripheral side. Therefore, the generation of the leakage magnetic flux can be effectively suppressed, and the thrust of the first movable coil 17 and the second movable coil 18 can be improved.

In addition, since the pair of facing portions 30 and the coupling portion 42 are integrally formed, the thrust can be improved without increasing the number of components.

An outer yoke 19D according to the fourth modification is formed in a shape in which a plurality of work holes 40 is formed in the coupling portion 42D (see FIG. 16). The work holes 40 work to reduce the magnetic flux density generated in the coupling portion 42D by the fixed rod 16.

The work holes 40 are located apart from each other in the coupling direction of the magnets 20 and the inner yokes 21, and are formed at positions corresponding to the inner yokes 21, for example. The shape of the work holes 40 is, for example, a circular shape, but may be other shapes such as a rectangular shape. However, since formation of the work holes 40 in a circular shape makes it hard to concentrate stress at the opening edges of the work holes 40 and the work holes 40 in a circular shape can be machined easily, so that strength of the outer yoke 19D can be improved and manufacturing cost can be reduced.

Since the formation of the work holes 40 in coupling portion 42D as described above reduces the magnetic flux density generated in the outer yoke 19D by the fixed rod 16, the magnetic attraction force of the outer yoke 19D with respect to the fixed rod 16 is reduced, the deformation of the fixed rod 16 is effectively suppressed, and the reliability of the operation of the linear actuator 15 can be improved.

In addition, since the work holes 40 are formed at the positions corresponding to the inner yokes 21, the work holes 40 are located corresponding to the portions of the highest magnetic flux densities in the fixed rod 16, so that the effect of reducing the magnetic attraction forces of the coupling portion 42D with respect to the fixed rod 16 is enhanced, and the deformation of the fixed rod 16 can be more effectively prevented.

Moreover, similarly to the outer yoke 19A, the outer yoke 19D may be configured such that the size of the first work holes 40X formed at the positions corresponding to the end-side inner yokes 21X is larger than the size of the second work holes 40Y formed at the positions corresponding to the inner yokes 21 other than the end-side inner yokes 21X.

The configuration described above reduces the thrust of the first movable coil 17 and the thrust of the second movable coil 18 at both ends of the fixed rod 16, and reduces the difference in the thrust of the first movable coil 17 and the second movable coil 18 in portions other than both ends of the fixed rod 16, so that it is possible to ensure an appropriate moving state of the first movable coil 17 and the second movable coil 18 with respect to the fixed rod 16.

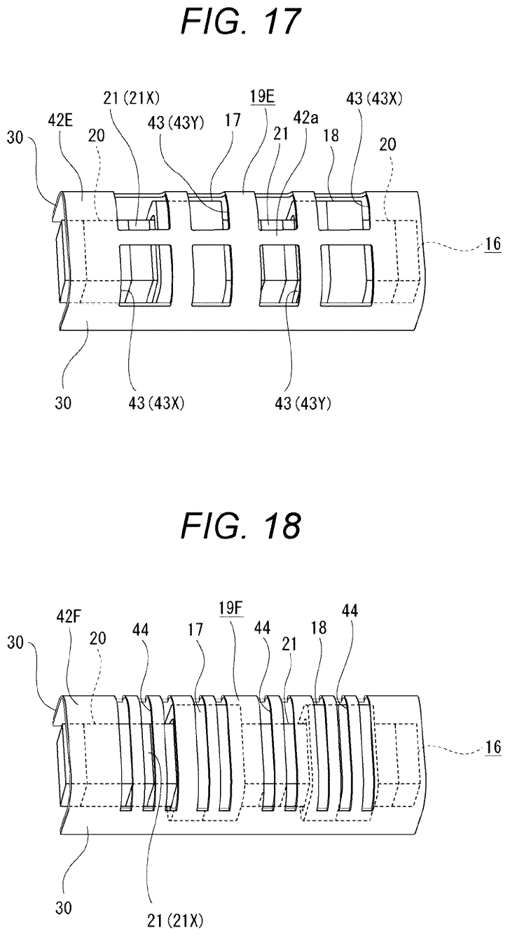

Although the example of the outer yoke 19D in which the work holes 40 are formed has been described above, as a fifth modification, an outer yoke 19E in which work holes 43 are formed instead of the work holes 40 may be configured (see FIG. 17). The outer yoke 19E is formed in a shape in which the plurality of work holes 43 is formed in a coupling portion 42E, and the work holes 43 work to reduce the magnetic flux density generated in the outer yoke 19D by the fixed rod 16.

Note that, in the outer yoke 19E, the work holes 43 may be formed at positions from the coupling portion 42E to the facing portions 30.

The work holes 43 are located apart from each other in the coupling direction of the magnets 20 and the inner yokes 21, and are formed on both sides of the coupling portion 42E in the width direction at positions corresponding to the inner yokes 21, for example. The shape of the work holes 43 is, for example, a rectangular shape.

The coupling portion 42E includes a partition 42a provided at the center portion in the width direction and extending in the coupling direction of the magnets 20 and the inner yokes 21, and the partition 42a partitions two work holes 43 aligned in the width direction.

Since the outer yoke 19E includes the partition 42a at the center portion in the width direction as described above, the partition 42a has a function of reinforcing the coupling portion 42E, and high strength of the outer yoke 19E is secured by the partition 42a.

Since the formation of the work holes 43 in the coupling portion 42E as described above reduces the magnetic flux density generated in the outer yoke 19E by the fixed rod 16, the magnetic attraction force of the outer yoke 19E with respect to the fixed rod 16 is reduced, the deformation of the fixed rod 16 is effectively suppressed, and the reliability of the operation of the linear actuator 15 can be improved.

In addition, since the work holes 43 are formed at the positions corresponding to the inner yokes 21, the work holes 43 are located corresponding to the portions of the highest magnetic flux densities in the fixed rod 16, so that the effect of reducing the magnetic attraction force of the coupling portion 42E with respect to the fixed rod 16 is enhanced, and the deformation of the fixed rod 16 can be more effectively prevented.

Moreover, similarly to the outer yoke 19D, the outer yoke 19E may be configured such that the size of the first work holes 43X formed at the positions corresponding to the end-side inner yokes 21X is larger than the size of the second work holes 43Y formed at the positions corresponding to the inner yokes 21 other than the end-side inner yokes 21X.

The configuration described above reduces the thrust of the first movable coil 17 and the thrust of the second movable coil 18 at both ends of the fixed rod 16, and reduces the difference in the thrust of the first movable coil 17 and the second movable coil 18 in portions other than both ends of the fixed rod 16, so that it is possible to ensure an appropriate moving state of the first movable coil 17 and the second movable coil 18 with respect to the fixed rod 16.

Furthermore, although the example of the outer yoke 19D in which the work holes 40 are formed has been described above, as a sixth modification, an outer yoke 19F in which work holes 44 are formed instead of the work holes 40 may be configured (see FIG. 18). The outer yoke 19F is formed in a shape in which a plurality of work holes 44 is formed in the coupling portion 42F, and the work holes 44 work to reduce the magnetic flux density generated in the outer yoke 19F by the fixed rod 16.

Note that, in the outer yoke 19F, the work holes 44 may be formed at positions from a coupling portion 42F to the facing portions 30.

The work holes 44 are located apart from each other in the coupling direction of the magnets 20 and the inner yokes 21, and are formed in a slit shape.

The formation of the slit-shaped work holes 44 in the outer yoke 19F as described above reduces the opening area of each of the work holes 44 in the coupling portion 42F, securing high strength of the outer yoke 19F.

Since the formation of the work holes 44 in the coupling portion 42F as described above reduces the magnetic flux density generated in the outer yoke 19F by the fixed rod 16, the magnetic attraction force of the outer yoke 19F with respect to the fixed rod 16 is reduced, the deformation of the fixed rod 16 is effectively suppressed, and the reliability of the operation of the linear actuator 15 can be improved.

In addition, since the work holes 44 are formed at the positions corresponding to the inner yokes 21, the work holes 44 are located corresponding to the portions of the highest magnetic flux density in the fixed rod 16, so that the effect of reducing the magnetic flux densities generated in the coupling portion 42F by the fixed rod 16 is enhanced, and the deformation of the fixed rod 16 can be more effectively prevented.

Moreover, the outer yoke 19F may be configured such that the number of the work holes 44 formed at positions corresponding to the end-side inner yokes 21X is larger than the number of the work holes 44 formed at positions corresponding to the inner yokes 21 other than the end-side inner yokes 21X. Specifically, for example, three work holes 44 may be formed at positions corresponding to the end-side inner yokes 21X, and for example, two work holes 44 may be formed at positions corresponding to the inner yokes 21 other than the end-side inner yokes 21X.

The configuration described above reduces the thrust of the first movable coil 17 and the thrust of the second movable coil 18 at both ends of the fixed rod 16, and reduces the difference in the thrust of the first movable coil 17 and the second movable coil 18 in portions other than both ends of the fixed rod 16, so that it is possible to ensure an appropriate moving state of the first movable coil 17 and the second movable coil 18 with respect to the fixed rod 16.

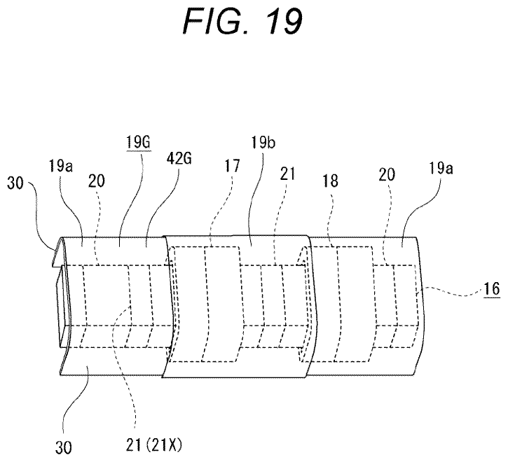

An outer yoke 19G according to the seventh modification is an example in which the thicknesses of the magnets 20 and the inner yokes 21 are changed in the coupling direction (see FIG. 19).

The outer yoke 19G includes, for example, portions on both end sides in the coupling direction as thin portions 19a, and a portion between the thin portions 19a as a general portion 19b. The thickness of the thin portions 19a is smaller than the thickness of the general portion 19b. Note that the general portion 19b may have a configuration in which a plurality of layers is stacked in the thickness direction.

Since the thin portions 19a provided as described above reduce the magnetic flux density generated in the thin portions 19a by the fixed rod 16 as compared with the magnetic flux density generated in the general portion 19b to reduce the magnetic attraction force of the outer yoke 19G with respect to the fixed rod 16, the deformation of the fixed rod 16 is effectively suppressed, and the reliability of the operation of the linear actuator 15 can be improved.

Moreover, the outer yoke 19G may be configured such that the thin portions 19a are located corresponding to the end-side inner yokes 21X, and the general portion 19b is provided corresponding to the inner yoke 21 other than the end-side inner yokes 21X.

The configuration described above reduces the thrust of the first movable coil 17 and the thrust of the second movable coil 18 at both ends of the fixed rod 16, and reduces the difference in the thrust of the first movable coil 17 and the second movable coil 18 in portions other than both ends of the fixed rod 16, so that it is possible to ensure an appropriate moving state of the first movable coil 17 and the second movable coil 18 with respect to the fixed rod 16.

Note that, although the outer yokes 19A, 19B, 19D, 19E, 19F, and 19G have been described above as examples of an outer yoke for reducing the magnetic flux density and the magnetic attraction force by the work holes 40 and the like, it is possible to adjust the thrust generated in the first movable coil 17 and the second movable coil 18 by adjusting the magnetic flux density by adjusting the size of the work holes 40 and the like.

Furthermore, adjustment of the magnetic flux density can suppress fluctuation of the thrust depending on the moving position of the movable body and reduce unevenness of the thrust, which stabilizes and increases the speed at the time of focusing and zooming, and improves the accuracy of the stop position of the movable body, and the like.

Note that the size and formation positions of the work holes 40, the work notches 41, and the like in each modification described above can be arbitrarily set, and for example, a configuration in which the work holes 40, the work notches 41, and the like are formed only at positions corresponding to the portions on both end sides of the fixed rod 16 and are not formed in portions other than the portions on both end sides of the fixed rod 16 can be adopted.

In the above description, the fixed rod 16 is covered with the outer yoke from both sides or three sides on the outer peripheral side as an example. However, the fixed rod 16 may be covered with the outer yoke only from one side on the outer peripheral side. Furthermore, the shape of the facing portions and the coupling portion is not limited to the flat plate shape, and for example, may a curved surface shape protruding to the side opposite to the fixed rod 16.

### Performance of Linear Actuator

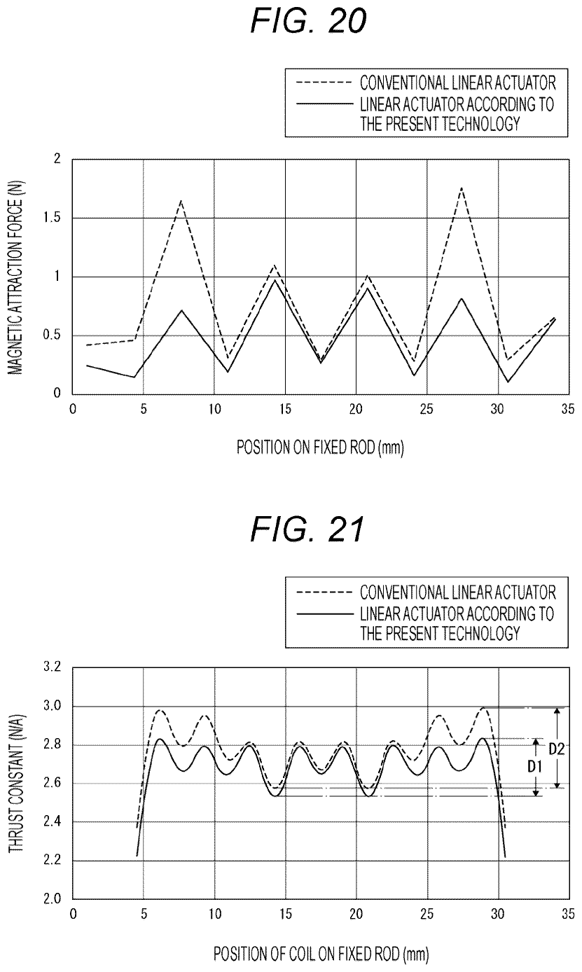

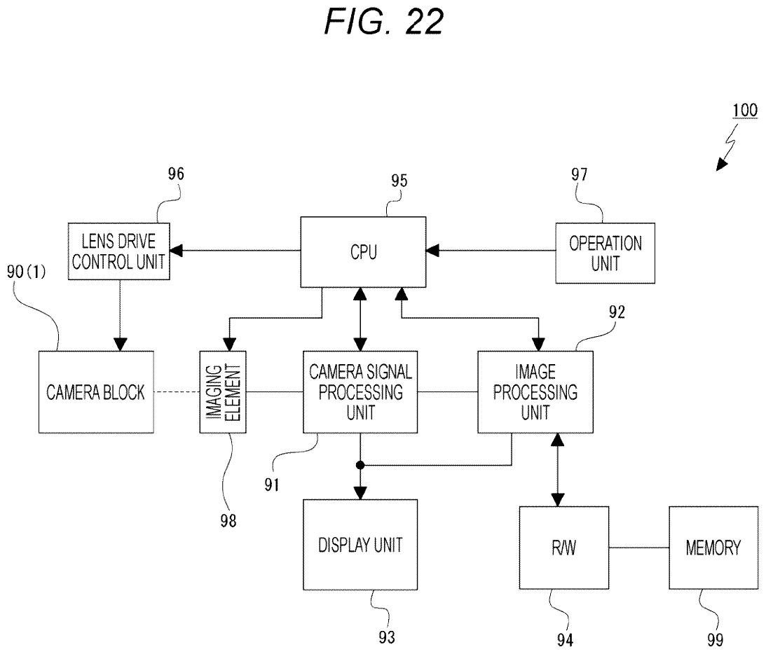

Next, the performance of the linear actuator 15 will be described (see FIGS. 20 and 21).

In order to confirm the performance of the linear actuator 15, a measurement test was performed to measure the magnitude of the magnetic attraction force with respect to each position on the fixed rod and the thrust generated in the movable coil, for a conventional linear actuator in which a work hole was not formed and the linear actuator according to the present technology in which the work holes were formed.

In FIG. 20, the horizontal axis represents “position on fixed rod”, and the vertical axis represents “attraction force of outer yoke with respect to fixed rod”. Since the magnetic attraction force increases at a position where the magnetic flux density is high, the magnetic attraction force increases at a position where the inner yoke exists.

In FIG. 20, it can be seen that the position where each peak of the magnetic attraction force occurs is the position where the inner yoke exists, and the linear actuator in which the work holes are formed has smaller peak values than the linear actuator in which a work hole is not formed.

Therefore, it was confirmed that the magnetic attraction force of the outer yoke with respect to the fixed rod was reduced by forming the work holes.

In FIG. 21, the horizontal axis represents “position of movable coil on fixed rod”, and the vertical axis represents “thrust constant of coil”. Since the thrust generated in the movable coil is obtained by the product of the thrust constant and the value of the current flowing through the movable coil, it can be considered that the thrust generated in the movable coil is larger at a position where the value of the thrust constant is larger. Since the thrust constant increases at a position where the magnetic flux density is high, the thrust constant increases at a position where the inner yoke exists. In addition, since the magnetic flux density at both ends is larger than that at the center portion of the fixed rod, the thrust constant is also larger near both ends.

In FIG. 21, it can be seen that a difference D1 between the maximum value and the minimum value of the thrust constant in the linear actuator in which the work holes are formed is smaller than a difference D2 between the maximum value and the minimum value of the thrust constant in the linear actuator in which a work hole is not formed.

Therefore, it was confirmed that the difference in thrust depending on the position of the movable coil on the fixed rod was reduced by forming the work holes.

### Summary

As described above, in the linear actuator 15, the interchangeable lens 1 including the linear actuator 15, and the imaging device 100 including the linear actuator 15, the plurality of tubular movable coils (17 and 18) through which the fixed rod 16 is inserted and movable in the coupling direction of the magnets 20 and the inner yokes 21 with respect to the fixed rod 16 is provided, and the plurality of movable coils is movable individually with respect to the fixed rod 16.

Therefore, each of the plurality of movable coils inserted into the fixed rod 16 is energized, so that each movable coil is individually moved with respect to the fixed rod 16. Therefore, the fixed rod 16 is not necessary for each movable coil, and the number of components for holding both ends of the fixed rod 16 is reduced, reducing the arrangement space of the units, so that downsizing can be achieved.

Moreover, since the fixed rod 16 is not necessary for each movable coil and the number of components for holding both ends of the fixed rod 16 is reduced, it is possible to reduce the manufacturing cost and the number of parts.

Moreover, it is also possible to arbitrarily extend the length of the fixed rod 16 to adjust the movement stroke of each movable coil or to increase the number of movable coils, enabling significant improvement of the degree of freedom in design.

### One Embodiment of Imaging Device

Hereinafter, a configuration example of an embodiment of the imaging device according to the present technology will be described (see FIG. 21).

The imaging device 100 includes a camera block 90 attached thereto and having an imaging function, and includes a camera signal processing unit 91 that performs signal processing such as analog-digital conversion of a captured image signal, and an image processing unit 92 that performs recording/reproducing processing of the image signal. Furthermore, the imaging device 100 includes a display unit 93 that displays a captured image and the like, a reader/writer (R/W) 94 that writes and reads an image signal to and from a memory 99, a central processing unit (CPU) 95 that controls the entire imaging device 100, a lens drive control unit 96 that controls driving of the lens provided in the camera block 90, and an operation unit 97 (102) such as various switches on which predetermined operations are performed by a user.

The camera block 90 is, for example, the interchangeable lens 1.

The imaging device 100 is provided with an imaging element 98 (104) such as a CCD or a CMOS that converts an optical image captured by the camera block 90 into an electrical signal.

The camera signal processing unit 91 performs various types of signal processing such as conversion of an output signal from the imaging element 98 into a digital signal, noise removal, image quality correction, and conversion into a luminance/color difference signal.

The image processing unit 92 performs compression encoding/decompression decoding processing of the image signal based on a predetermined image data format, conversion processing of data specification such as resolution, and the like.

The display unit 93 has a function of displaying various types of data such as an operating state of a user on the operation unit 97 and the captured image. Note that the imaging device 100 may not include the display unit 93, and may be configured such that captured image data is sent to another display device and an image is displayed.

The R/W 94 writes the image data encoded by the image processing unit 92 in the memory 99 and reads the image data recorded in the memory 99.

The CPU 95 serves as a control processing unit that controls each circuit block provided in the imaging device 100, and controls each circuit block on the basis of an instruction input signal and the like from the operation unit 97.

The lens drive control unit 96 controls a drive source that moves the lens on the basis of a control signal from the CPU 95.

The operation unit 97 outputs the instruction input signal according to a user operation to the CPU 95.

The memory 99 is, for example, a semiconductor memory attachable to and detachable from a slot connected to the R/W 94 or a semiconductor memory incorporated in the imaging device 100 in advance.

The operation in the imaging device 100 is hereinafter described.

In a standby state for imaging, under the control of the CPU 95, the captured image signal is output to the display unit 93 via the camera signal processing unit 91 and displayed as a camera through image. Furthermore, when the instruction input signal is input from the operation unit 97, the CPU 95 outputs the control signal to the lens drive control unit 96, and lenses are moved on the basis of the control of the lens drive control unit 96.

When an imaging operation is performed by the instruction input signal from the operation unit 97, the captured image signal is output from the camera signal processing unit 91 to the image processing unit 92, subjected to the compression encoding processing, and converted into digital data in a predetermined data format. The converted data is output to the R/W 94 and written in the memory 99.

In a case of reproducing the image data recorded in the memory 99, predetermined image data is read from the memory 99 by the R/W 94 in response to the operation on the operation unit 97, and the decompression decoding processing is performed thereon by the image processing unit 92, then a reproduced image signal is output to the display unit 93 and a reproduced image is displayed.

Note that, in the present technology, the term “imaging” refers to processing including only a part of or all of a series of processing starting from the photoelectric conversion processing of converting the captured light into the electric signal by the imaging element 98, processing such as the conversion of the output signal from the imaging element 98 into the digital signal, the noise removal, the image quality correction, and the conversion into the luminance/color difference signal by the camera signal processing unit 91, the compression encoding/decompression decoding processing of the image signal based on a predetermined image data format and the conversion processing of the data specification such as the resolution by the image processing unit 92, until writing processing of the image signal in the memory 99 by the R/W 94.

That is, the term “imaging” may refer only to the photoelectric conversion processing that converts the captured light into the electric signal by the imaging element 98, may refer to processing from the photoelectric conversion processing that converts the captured light into the electric signal by the imaging element 98 to processing such as the conversion of the output signal from the imaging element 98 into the digital signal, the noise removal, the image quality correction, and the conversion into the luminance/color difference signal by the camera signal processing unit 91, may refer to processing from the photoelectric conversion processing that converts the captured light into the electric signal by the imaging element 98 through the processing such as the conversion of the output signal from the imaging element 98 into the digital signal, the noise removal, the image quality correction, and the conversion into the luminance/color difference signal by the camera signal processing unit 91 to the compression encoding/decompression decoding processing of the image signal based on a predetermined image data format and the conversion processing of the data specification such as the resolution by the image processing unit 92, may refer to processing from the photoelectric conversion processing of converting the captured light into the electric signal by the imaging element 98, the processing such as the conversion of the output signal from the imaging element 98 into the digital signal, the noise removal, the image quality correction, and the conversion into the luminance/color difference signal by the camera signal processing unit 91, and the compression encoding/decompression decoding processing of the image signal based on a predetermined image data format and the conversion processing of the data specification such as the resolution by the image processing unit 92, and may refer to the processing until the writing processing of the image signal in the memory 99 by the R/W 94.

### Present Technology

The present technology can have the following configurations.
(1)

A linear actuator including:
a fixed rod including at least two magnets and at least one inner yoke, the magnets and the inner yoke being alternately coupled, and the magnets having poles of the same polarity coupled to both sides of the inner yoke; and
a plurality of tubular movable coils through which the fixed rod is inserted, the plurality of movable coils being movable in a coupling direction of the magnets and the inner yoke with respect to the fixed rod, in which
the plurality of movable coils is individually movable with respect to the fixed rod.
(2)

The linear actuator according to (1), in which
an outer yoke that covers parts of the fixed rod and the movable coils from an outer peripheral side is provided in a fixed state, and
the outer yoke includes facing portions in a pair located on opposite sides across the fixed rod.
(3)

The linear actuator according to (2), in which
at least one work hole or work notch that reduces a magnetic flux density generated in the outer yoke by the fixed rod is formed in the facing portions.
(4)

The linear actuator according to (3), in which
the at least one work hole or work notch is formed at a position corresponding to the inner yoke.
(5)

The linear actuator according to (3) or (4), in which
ones of the at least one inner yoke located at both ends in the coupling direction are defined as end-side inner yokes,
ones of the at least one work hole formed at positions corresponding to the end-side inner yokes are defined as first work holes, and at least one of the at least one work hole formed at a position corresponding to the inner yoke other than the end-side inner yokes is defined as a second work hole, and
the size of the first work holes is larger than the size of the second work hole.
(6)

The linear actuator according to (1), in which
an outer yoke that covers at least parts of the fixed rod and the movable coils from an outer peripheral side is provided in a fixed state, and
at least one work hole that reduces a magnetic flux density generated in the outer yoke by the fixed rod is formed in the outer yoke.
(7)

The linear actuator according to (6), in which
the at least one work hole is formed at a position corresponding to the inner yoke.
(8)

The linear actuator according to (7), in which
ones of the at least one inner yoke located at both ends in the coupling direction are defined as end-side inner yokes,
ones of the at least one work hole formed at positions corresponding to the end-side inner yokes are defined as first work holes, and at least one of the at least one work hole formed at a position corresponding to the inner yoke other than the end-side inner yokes is defined as a second work hole, and
the size of the first work holes is larger than the size of the second work hole.
(9)

The linear actuator according to (6), in which
a thickness of the outer yoke is changed in the coupling direction.
(10)

An interchangeable lens including:
a movable body movable in an optical axis direction; and a linear actuator that moves the movable body in the optical axis direction,
the linear actuator including:
a fixed rod including at least two magnets and at least one inner yoke, the magnets and the inner yoke being alternately coupled, and the magnets having poles of the same polarity coupled to both sides of the inner yoke; and
a plurality of tubular movable coils through which the fixed rod is inserted, the plurality of movable coils being movable in a coupling direction of the magnets and the inner yoke with respect to the fixed rod, in which
the plurality of movable coils is individually movable with respect to the fixed rod.
(11)

An imaging device including:
an imaging element that converts an optical image into an electrical signal; a movable body movable in an optical axis direction; and a linear actuator that moves the movable body in the optical axis direction,
the linear actuator including:
a fixed rod including at least two magnets and at least one inner yoke, the magnets and the inner yoke being alternately coupled, and the magnets having poles of the same polarity coupled to both sides of the inner yoke; and
a plurality of tubular movable coils through which the fixed rod is inserted, the plurality of movable coils being movable in a coupling direction of the magnets and the inner yoke with respect to the fixed rod, in which
the plurality of movable coils is individually movable with respect to the fixed rod.

### REFERENCE SIGNS LIST

100 Imaging device
104 Imaging element
1 Interchangeable lens
15 Linear actuator
16 Fixed rod
17 First movable coil
18 Second movable coil
19 Outer yoke
20 Magnet
21 Inner yoke
30 Facing portion
19A Outer yoke
30A Facing portion
40 Action hole
21X End-side inner yoke
40X First work hole
40Y Second work hole
19B Outer yoke
30B Facing portion
41 Work notch
19C Outer yoke
42 Coupling portion
19D Outer yoke
42D Coupling portion
19E Outer yoke
42E Coupling portion
19F Outer yoke
42F Coupling portion
44 Action hole
19G Outer yoke
42G Coupling portion
98 Imaging element

1. A linear actuator comprising:
a fixed rod including at least two magnets and at least one inner yoke, the magnets and the inner yoke being alternately coupled, and the magnets having poles of the same polarity coupled to both sides of the inner yoke; and
a plurality of tubular movable coils through which the fixed rod is inserted, the plurality of movable coils being movable in a coupling direction of the magnets and the inner yoke with respect to the fixed rod, wherein
the plurality of movable coils is individually movable with respect to the fixed rod.

2. The linear actuator according to claim 1, wherein
an outer yoke that covers parts of the fixed rod and the movable coils from an outer peripheral side is provided in a fixed state, and
the outer yoke includes facing portions in a pair located on opposite sides across the fixed rod.

3. The linear actuator according to claim 2, wherein
at least one work hole or work notch that reduces a magnetic flux density generated in the outer yoke by the fixed rod is formed in the facing portions.

4. The linear actuator according to claim 3, wherein
the at least one work hole or work notch is formed at a position corresponding to the inner yoke.

5. The linear actuator according to claim 4, wherein
ones of the at least one inner yoke located at both ends in the coupling direction are defined as end-side inner yokes,
ones of the at least one work hole formed at positions corresponding to the end-side inner yokes are defined as first work holes, and at least one of the at least one work hole formed at a position corresponding to the inner yoke other than the end-side inner yokes is defined as a second work hole, and
the size of the first work holes is larger than the size of the second work hole.

6. The linear actuator according to claim 1, wherein
an outer yoke that covers at least parts of the fixed rod and the movable coils from an outer peripheral side is provided in a fixed state, and
at least one work hole that reduces a magnetic flux density generated in the outer yoke by the fixed rod is formed in the outer yoke.

7. The linear actuator according to claim 6, wherein
the work hole is formed at a position corresponding to the inner yoke.

8. The linear actuator according to claim 7, wherein
ones of the at least one inner yoke located at both ends in the coupling direction are defined as end-side inner yokes,
ones of the at least one work hole formed at positions corresponding to the end-side inner yokes are defined as first work holes, and at least one of the at least one work hole formed at a position corresponding to the inner yoke other than the end-side inner yokes is defined as a second work hole, and
the size of the first work holes is larger than the size of the second work hole.

9. The linear actuator according to claim 6, wherein
a thickness of the outer yoke is changed in the coupling direction.

10. An interchangeable lens comprising:
a movable body movable in an optical axis direction; and a linear actuator that moves the movable body in the optical axis direction,
the linear actuator including:
a fixed rod including at least two magnets and at least one inner yoke, the magnets and the inner yoke being alternately coupled, and the magnets having poles of the same polarity coupled to both sides of the inner yoke; and
a plurality of tubular movable coils through which the fixed rod is inserted, the plurality of movable coils being movable in a coupling direction of the magnets and the inner yoke with respect to the fixed rod, wherein
the plurality of movable coils is individually movable with respect to the fixed rod.

11. An imaging device comprising:
an imaging element that converts an optical image into an electrical signal; a movable body movable in an optical axis direction; and a linear actuator that moves the movable body in the optical axis direction,
the linear actuator including:
a fixed rod including at least two magnets and at least one inner yoke, the magnets and the inner yoke being alternately coupled, and the magnets having poles of the same polarity coupled to both sides of the inner yoke; and
a plurality of tubular movable coils through which the fixed rod is inserted, the plurality of movable coils being movable in a coupling direction of the magnets and the inner yoke with respect to the fixed rod, wherein
the plurality of movable coils is individually movable with respect to the fixed rod.
